(19) United States
(12) Patent Application Publication
(10) Pub. No.: US 2026/0065092 A1
(43) Pub. Date: Mar. 5, 2026

(54) AI MODEL REASONING METHOD

(71) Applicant: BEIJING XIAOMI MOBILE SOFTWARE CO., LTD., Beijing (CN)

(72) Inventor: Qin MU, Beijing (CN)

(73) Assignee: BEIJING XIAOMI MOBILE SOFTWARE CO., LTD., Beijing (CN)

(21) Appl. No.: 18/878,354

(22) PCT Filed: Jul. 1, 2022
(86) PCT No.: PCT/CN2022/103485

§ 371 Date: Dec. 23, 2024

(51) Int. Cl. G06N 5/04

(52) U.S. Cl. CPC G06N 5/04

(57) ABSTRACT

Disclosed in the embodiments of the present application are a reasoning method and apparatus, which can be applied to wireless artificial intelligence (AI) systems. The method comprises: in the solution, a third device sending an AI model reasoning task to a second device; and when the second device does not have a condition for independent reasoning, in response to receiving an AI model reasoning request, which is sent by means of the second device, the first device assisting the second device with completing the AI model reasoning task. Therefore, the second device can be able to indirectly perform reasoning in response to a requirement for providing or using an AI model reasoning result, thereby benefiting from wireless AI.

### CROSS-REFERENCE TO RELATED APPLICATION

This application is the U.S. National Stage Application of International Application No. PCT/CN2022/103485, filed on Jul. 1, 2022, the entire disclosure of which is incorporated herein by reference.

### TECHNICAL FIELD

The disclosure relates to the field of communication technologies, and in particular, to a method and an apparatus for AI model inference.

### BACKGROUND

In recent years, artificial intelligence (AI) technology has made continuous breakthroughs in multiple fields. The continuous development of intelligent voice, computer vision and other fields not only brings rich and colorful applications to intelligent terminals, but also has extensive applications in education, transportation, home furnishings, healthcare, retail, security and other fields, bringing convenience to people's lives and promoting industrial upgrading in various industries. AI technology is also accelerating its cross penetration with other disciplinary fields, integrating knowledge from different disciplines while providing new directions and methods for the development of different disciplines.

In the related art, the main participants of AI technology are base stations and terminal devices. The base station provides AI models and the terminal performs inference. As terminal devices require certain hardware capabilities and software platforms for inference, high-end terminal devices with higher processing capabilities are required. However, in practical applications, there are still a group of terminal devices with insufficient processing capabilities to execute inference.

### SUMMARY

In a first aspect, embodiments of the present disclosure provide a method for AI mode inference. The method is performed by a first device, and includes:
in response to receiving an AI model inference request sent by a second device, assisting the second device in completing an AI model inference task, wherein the AI model inference request is sent by the second device to the first device in response to a need to provide or use an inference result of an AI model.

In a second aspect, embodiments of the present disclosure provide a method for AI model inference, The method is performed by a second device, and includes:
in response to the second device providing or using an inference result of an AI model, sending an AI model inference request to the first device, wherein the AI model inference request indicates a need to assist the second device in completing an AI model inference task.

In a third aspect, embodiments of the present disclosure provide a method for AI model inference. The method is performed by a third device, and includes:
in response to receiving information reported by a second device about having AI model inference capability, sending an AI model inference task to the second device, so that the first device assists the second device in completing the inference task. The second device reports specific information about the AI model inference capability in response to the need for the second device to provide or use the inference result of the AI model.

### BRIEF DESCRIPTION OF THE DRAWINGS

In order to provide a clearer explanation of the technical solution in the embodiments or background technology of the present disclosure, the accompanying drawings required for use in the embodiments or background technology of the present disclosure will be described below.

FIG. 1 is a schematic diagram of an architecture of an inference system provided in an embodiment of the present disclosure.

FIG. 2 is a schematic flowchart of an inference method provided in an embodiment of the present disclosure.

FIG. 3 is a schematic flowchart of another inference method provided in an embodiment of the present disclosure.

FIG. 4 is a schematic flowchart of another inference method provided in an embodiment of the present disclosure.

FIG. 5 is a schematic flowchart of another inference method provided in an embodiment of the present disclosure.

FIG. 6 is a schematic flowchart of another inference method provided in an embodiment of the present disclosure.

FIG. 7 is a schematic flowchart of another inference method provided in an embodiment of the present disclosure.

FIG. 8 is a schematic flowchart of another inference method provided in an embodiment of the present disclosure.

FIG. 9 is a schematic flowchart of another inference method provided in an embodiment of the present disclosure.

FIG. 10 is a schematic flowchart of another inference method provided in an embodiment of the present disclosure.

FIG. 11 is a schematic flowchart of another inference method provided in an embodiment of the present disclosure.

FIG. 12 is a schematic flowchart of another inference method provided in an embodiment of the present disclosure.

FIG. 13 is a schematic flowchart of another inference method provided in an embodiment of the present disclosure.

FIG. 14 is a schematic flowchart of another inference method provided in an embodiment of the present disclosure.

FIG. 15 is a schematic flowchart of another inference method provided in an embodiment of the present disclosure.

FIG. 16 is a schematic flowchart of another inference method provided in an embodiment of the present disclosure.

FIG. 17 is a schematic flowchart of another inference method provided in an embodiment of the present disclosure.

FIG. 18 is a schematic flowchart of another inference method provided in an embodiment of the present disclosure.

FIG. 19 is a schematic flowchart of another inference method provided in an embodiment of the present disclosure.

FIG. 20 is a schematic flowchart of another inference method provided in an embodiment of the present disclosure.

FIG. 21 is a schematic flowchart of another inference method provided in an embodiment of the present disclosure.

FIG. 22 is a schematic flowchart of another inference method provided in an embodiment of the present disclosure.

FIG. 23 is a schematic flowchart of another inference method provided in an embodiment of the present disclosure.

FIG. 24 is a block diagram of an apparatus for inference provided in an embodiment of the present disclosure.

FIG. 25 is a block diagram of another inference device provided in an embodiment of the present disclosure.

FIG. 26 is a block diagram of another inference device provided in an embodiment of the present disclosure.

FIG. 27 is a block diagram of another inference device provided in an embodiment of the present disclosure.

FIG. 28 is a block diagram of another inference device provided in an embodiment of the present disclosure.

### DETAILED DESCRIPTION

Please refer to FIG. 1, which is a schematic diagram of an architecture of an inference system provided in an embodiment of the present disclosure. The inference system may include, but is not limited to, a first device 101, a second device 102, and a third device 103. The number and form of devices shown in FIG. 1 are for example only and do not constitute a limitation on the embodiments of the present disclosure. In practical applications, it may include two or more first devices 101, two or more second devices 102, and two or more third devices 103. The system shown in FIG. 1 includes one first device 101, one second device 102, and one third device 103.

The first device 101 in embodiments of the present disclosure is a third-party AI processing platform, which is a server or processor outside a wireless cellular system.

The second device 102 in embodiments of the present disclosure is an entity on the user side used for receiving or transmitting signals, such as a mobile phone. The first device can also be referred to as a terminal device, user equipment (UE), mobile station (MS), mobile terminal device (MT), etc. The processing capability of the second device 102 is insufficient to independently complete the AI model inference task. The specific technology and device form adopted by the second device 102 are not limited in embodiments of the present disclosure.

The third device 103 in embodiments of the present disclosure is a network device. The network device in embodiments of the present disclosure is an entity on the network side used for transmitting or receiving signals. For example, the network device 101 can be an evolved NodeB (eNB), a transmission reception point (TRP), a next generation NodeB (gNB) in an NR system, a base station in other future mobile communication systems, or an access node in a wireless fidelity (WiFi) system. The specific technology and device form adopted by the network device is not limited in embodiments of the present disclosure. The network device provided in embodiments of the present disclosure may be composed of a central unit (CU) and a distributed unit (DU), where the CU may also be referred to as a control unit. The CU-DU structure can be used to separate the protocol layers of network device, such as base station, with some protocol layer functions centrally controlled by the CU and the remaining or all protocol layer functions distributed in the DU, which is centrally controlled by the CU.

The following provides a detailed introduction to the method and apparatus for AI model inference provided in this disclosure, in conjunction with the accompanying drawings.

Please refer to FIG. 2, which is a schematic flowchart of an inference method provided in an embodiment of the present disclosure. The method is performed by a first device, and as shown in FIG. 2, the method may include but is not limited to following steps.

Step S201, in response to receiving an AI model inference request sent by a second device, assisting the second device in completing an AI model inference task, wherein the AI model inference request is sent by the second device to the first device in response to a need to provide or use an inference result of the AI model

In response to receiving information about having AI model inference capability reported by the second device, the third device sends an AI model inference task to the second device. When the second device does not have conditions for independent inference, such as limited hardware conditions of incompatible AI processing platforms, the second device sends an AI model inference request to the first device, and the first device assists the second device in completing the AI model inference task.

As a feasible implementation of embodiments of the present disclosure, the first device is a server or processor outside the wireless cellular system. The specific form of the first device is not limited.

In this solution, the third device sends the AI model inference task to the second device. When the second device does not have the conditions for independent inference, the first device, in response to the AI model inference request sent by the second device, assists the second device in completing the AI model inference task, so that the second device can respond to the need to provide or use the inference result of the AI model, enabling the second device to indirectly have inference ability and benefiting from wireless AI.

Embodiments of the present disclosure provide another inference method. FIG. 3 is a schematic flowchart of another inference method provided in an embodiment of the present disclosure. The method is performed by the first device. The inference method can be executed separately, combined with any of the embodiments or possible implementations in this disclosure, or combined with any technical solution in the related art.

As shown in FIG. 3, the inference method may include the following step.

Step S301, in response to receiving an AI model inference request sent by a second device, assisting the second device in completing an AI model inference task, wherein assisting the second device in completing the AI model inference task includes any of the first device independently completing the AI model inference task; the second device and the first device jointly completing the AI model inference task; the first device, the second device, and a third device jointly completing the AI model inference task.

The AI model inference request is sent by the second device to the first device in response to a need to provide an inference result of the AI model or use an inference result of the AI model.

When the first device serves as the provider of the AI model, it can independently complete the model inference task, or the first device and the second device can jointly complete the model inference task.

When the first device serves as the user of the AI model, it needs to receive the AI model transmitted by the third device, and then the first device, the second device, and the third device jointly complete the model inference task.

In this solution, the third device sends the AI model inference task to the second device. When the second device does not have the conditions for independent inference, the first device responds to the AI model inference request sent by the second device to assist the second device in completing the AI model inference task, so that the second device can respond to the need to provide or use the inference result of the AI model, indirectly enabling the second device to have inference ability and benefiting from wireless AI.

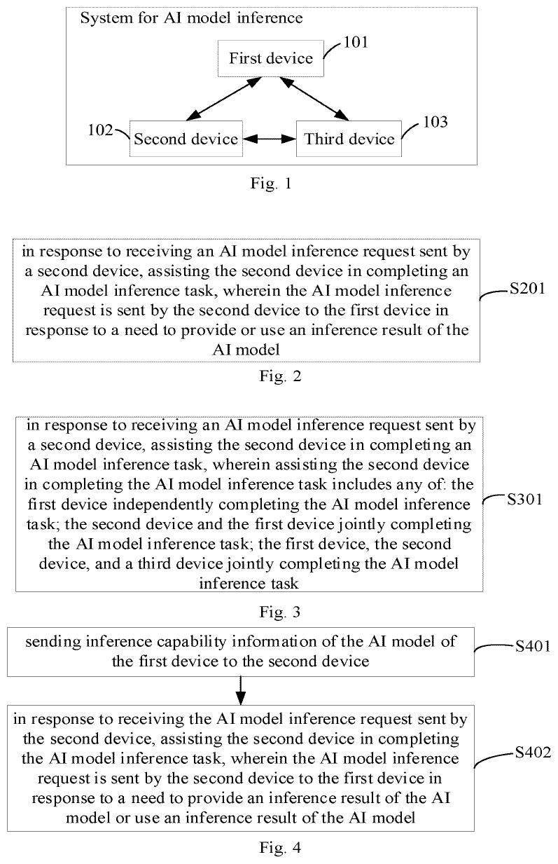

Embodiments of the present disclosure provide another inference method. FIG. 4 is a schematic flowchart of another inference method provided in an embodiment of the present disclosure. The method is performed by the first device. The inference method can be executed separately, combined with any of the embodiments or possible implementations in this disclosure, or combined with any technical solution in the related art.

As shown in FIG. 4, the inference method may include the following steps

Step S401, sending inference capability information of the AI model of the first device to the second device.

The first device sends the inference capability information of the AI model to the second device, with the purpose of using the second device as a relay to forward the obtained inference capability information to the third device, in order to achieve information synchronization of the AI model during transmission, so that the third device can determine whether to allow the second device to use the functions of the wireless AI model or which use cases of the wireless AI model to use based on the inference capability information.

In response to the AI model inference capability information reported by the second device, the third device sends an AI model inference task to the second device. When the second device does not have the conditions for independent inference, such as limited hardware conditions or incompatible AI processing platforms, the second device sends an AI model inference request to the first device, and the first device assists the second device in completing the AI model inference task.

For example, the inference capability information of the AI model includes at least one of: AI model information, AI processing platform framework information and AI processing capability information.

As a feasible implementation of embodiments of the present disclosure, the first device is a server or processor outside the wireless cellular system. The specific form of the first device is not limited.

Step S402, in response to receiving the AI model inference request sent by the second device, assisting the second device in completing the AI model inference task, wherein the AI model inference request is sent by the second device to the first device in response to a need to provide an inference result of the AI model or use an inference result of the AI model.

In this solution, the third device sends the AI model inference task to the second device in response to receiving information about having AI model inference capability reported by the second device. When the second device does not have the conditions for independent inference, the first device responds to the AI model inference request sent by the second device to assist the second device in completing the AI model inference task, so that the second device can respond to the need to provide the inference result of the AI model or use the inference result of the AI model, indirectly enabling the second device to have inference capability and benefiting from wireless AI.

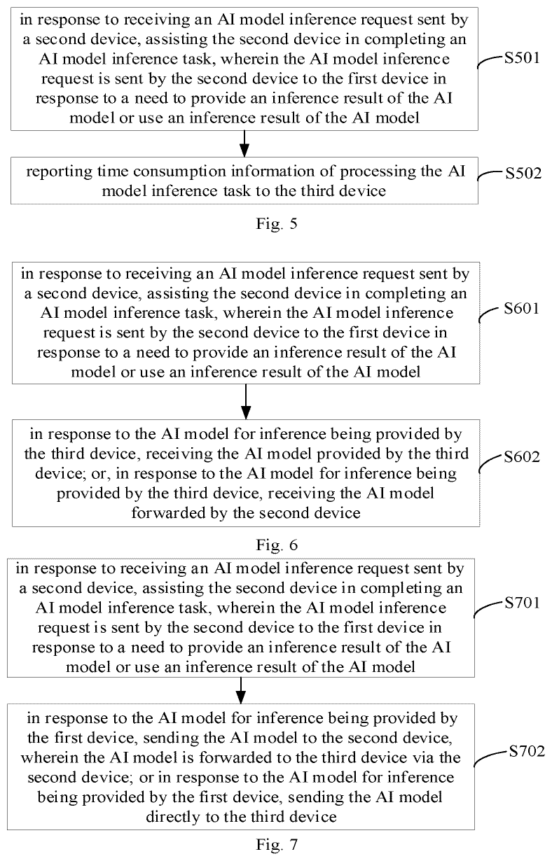

Embodiments of the present disclosure provide another inference method. FIG. 5 is a schematic flowchart of another inference method provided in an embodiment of the present disclosure. The method is performed by the first device. The inference method can be executed separately, combined with any of the embodiments or possible implementations in this disclosure, or combined with any technical solution in the related art.

As shown in FIG. 5, the inference method may include the following steps.

Step S501, in response to receiving an AI model inference request sent by a second device, assisting the second device in completing an AI model inference task, wherein the AI model inference request is sent by the second device to the first device in response to a need to provide an inference result of the AI model or use an inference result of the AI model.

When the second device does not have the conditions for independent inference, such as limited hardware conditions or incompatible AI processing platforms, the first device can assist the second device in AI inference.

As a feasible implementation of embodiments of the present disclosure, the first device is a server or processor outside the wireless cellular system. The specific form of the first device is not limited.

Assisting the second device in performing the AI model inference task includes any of the following: the first device independently completing the AI model inference task, the first device and the second device jointly completing the AI model inference task, or the first device, the second device, and the third device jointly completing the AI model inference task.

Step S502, reporting time consumption information of processing the AI model inference task to the third device.

The time consumption delay information for processing each AI task is determined based on the category of AI task processed in the AI model, and the time consumption/delay information is reported to the third device.

In this solution, the third device sends the AI model inference task to the second device in response to receiving information about having AI model inference capability reported by the second device. When the second device does not have the conditions for independent inference, the first device responds to the AI model inference request sent by the second device to assist the second device in completing the AI model inference task, so that the second device can respond to the need to provide the inference result of the AI model or use the inference result of the AI model, indirectly enabling the second device to have inference capability and benefiting from wireless AI.

Embodiments of the present disclosure provide another inference method. FIG. 6 is a schematic flowchart of another inference method provided in an embodiment of the present disclosure. The method is performed by the first device. The inference method can be executed separately, combined with any of the embodiments or possible implementations in this disclosure, or combined with any technical solution in the related art.

As shown in FIG. 6, the inference method may include the following steps.

Step S601, in response to receiving an AI model inference request sent by a second device, assisting the second device in completing an AI model inference task, wherein the AI model inference request is sent by the second device to the first device in response to a need to provide an inference result of the AI model or use an inference result of the AI model.

When the second device does not have the conditions for independent inference, such as limited hardware conditions or incompatible AI processing platforms, the first device can assist the second device in AI inference.

As a feasible implementation of embodiments of the present disclosure, the first device is a server or processor outside the wireless cellular system. The specific form of the first device is not limited.

Step S602, in response to the AI model for inference being provided by the third device, receiving the AI model provided by the third device; or, in response to the AI model for inference being provided by the third device, receiving the AI model forwarded by the second device.

For example, when the first device serves as the user of the AI model and the third device serves as the provider of the AI model, the first device receives the AI model transmitted by the third device.

In addition to the direct transmission of the AI model between the first device and the third device, this embodiment of the present disclosure also supports the intermediary of the second device, where the third device acts as the provider of the AI model and transmits the AI model to the second device, which then forwards the AI model to the first device. The transmission of the AI model is performed between the first device, the second device, and the third device.

The above process of transmitting the AI model is for illustrative purposes only and is not intended to limit the transmission order of the AI model to only include the implementation of the above examples.

In this solution, the third device sends the AI model inference task to the second device in response to receiving information about having AI model inference capability reported by the second device. When the second device does not have the conditions for independent inference, in response to the AI model inference request sent by the second device, the first device performs AI model transmission in at least two devices of the first device, the second device, and the third device, to complete the model inference task of the second device, indirectly enabling the second device to have inference capability and benefit from wireless AI.

Embodiments of the present disclosure provide another inference method. FIG. 7 is a schematic flowchart of another inference method provided in an embodiment of the present disclosure The method is performed by the first device. The inference method can be executed separately, combined with any of the embodiments or possible implementations in this disclosure, or combined with any technical solution in the related art.

As shown in FIG. 7, the inference method may include the following steps.

Step S701, in response to receiving an AI model inference request sent by a second device, assisting the second device in completing an AI model inference task, wherein the AI model inference request is sent by the second device to the first device in response to a need to provide an inference result of the AI model or use an inference result of the AI model.

When the second device does not have the conditions for independent inference, such as limited hardware conditions or incompatible AI processing platforms, the first device can assist the second device in AI inference.

As a feasible implementation of embodiments of the present disclosure, the first device is a server or processor outside the wireless cellular system. The specific form of the first device is not limited.

Step S702, in response to the AI model for inference being provided by the first device for inference, sending the AI model to the second device, wherein the AI model is forwarded to the third device via the second device; or in response to the AI model for inference being provided by the first device for inference, sending the AI model directly to the third device.

The scenario of the present embodiment is that the first device serves as the provider of the AI model and needs to transmit it to the user of the AI model (the third device). The third device assists the first device in executing the AI model inference task based on the received AI model. When transmitting the AI model from the first device to the third device, the process is similar to the process of the third device transmitting the AI model to the first device. The first device can directly transmit the AI model from the first device to the third device, or the first device can transmit the AI model to the second device and then the second device can transmit the AI model to the third device. The method of transmitting the AI model is not limited in embodiments of the present disclosure.

In this solution, the third device sends the AI model inference task to the second device in response to receiving information about having AI model inference capability reported by the second device. When the second device does not have the conditions for independent inference, the first device responds to the AI model inference request sent by the second device and performs AI model transmission in at least two devices, namely the first device, the second device, and the third device, to complete the model inference task of the second device, indirectly enabling the second device to have inference capability and benefit from wireless AI.

Embodiments of the present disclosure provide another inference method. FIG. 8 is a schematic flowchart of another inference method provided in an embodiment of the present disclosure. The method is performed by the first device. The inference method can be executed separately, combined with any of the embodiments or possible implementations in this disclosure, or combined with any technical solution in the related art.

As shown in FIG. 8, the inference method may include the following steps.

Step S801, in response to receiving an AI model inference request sent by a second device, assisting the second device in completing an AI model inference task, wherein the AI model inference request is sent by the second device to the first device in response to a need to provide an inference result of the AI model or use an inference result of the AI model.

When the second device does not have the conditions for independent inference, such as limited hardware conditions or incompatible AI processing platforms, the first device can assist the second device in AI inference.

As a feasible implementation of embodiments of the present disclosure, the first device is a server or processor outside the wireless cellular system. The specific form of the first device is not limited.

Step S802, sending the inference result to the second device, wherein the inference result is forwarded to the third device via the second device; or directly reporting the inference result to the third device.

As an implementation of embodiments of the present disclosure, after the first device assists the second device in completing the AI model inference task, the inference result is returned to the second device and uploaded to the third device by the second device.

As another implementation of embodiments of The present disclosure, after the first device assists the second device in completing the AI model inference task, the inference result is directly returned to the third device.

The network device in the embodiments of the present disclosure is an entity on the network side used for transmitting or receiving signals. For example, the network device can be an evolved NodeB (eNB), a transmission reception point (TRP), a next generation NodeB (gNB) in an NR system, a base station in other future mobile communication systems, or an access node in a wireless fidelity (WiFi) system. The specific technology and device form adopted by the network device is not limited in embodiments of the present disclosure. The network device provided in embodiments of the present disclosure may be composed of a central unit (CU) and a distributed unit (DU), where the CU may also be referred to as a control unit. The CU-DU structure can be used to separate the protocol layers of network device, such as base station, with some protocol layer functions centrally controlled by the CU and the remaining or all protocol layer functions distributed in the DU, which is centrally controlled by the CU.

In this solution, the third device sends the AI model inference task to the second device in response to receiving information about having AI model inference capability reported by the second device. When the second device does not have the conditions for independent inference, the first device responds to receiving the AI model inference request sent by the second device and assists in returning the inference result to the second device or the third device to assist the second device in completing the AI model inference task, indirectly enabling the second device to have inference capability and benefiting from wireless AI.

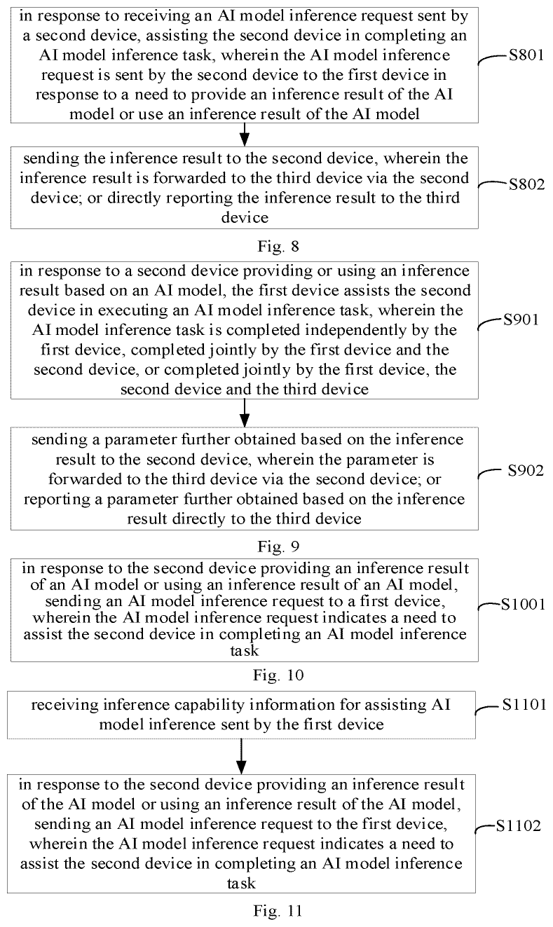

Embodiments of the present disclosure provide another inference method. FIG. 9 is a schematic flowchart of another inference method provided in an embodiment of the present disclosure. The method is performed by the first device. The inference method can be executed separately, combined with any of the embodiments or possible implementations in this disclosure, or combined with any technical solution in the related art

As shown in FIG. 9, the inference method may include the following steps.

Step 8901, in response to a second device providing or using an inference result based on an AI model, the first device assists the second device in executing an AI model inference task, wherein the AI model inference task is completed independently by the first device, completed jointly by the first device and the second device, or completed jointly by the first device, the second device and the third device.

When the second device does not have the conditions for independent inference, such as limited hardware conditions or incompatible AI processing platforms, the first device can assist the second device in AI inference.

As a feasible implementation of embodiments of the present disclosure, the first device is a server or processor outside the wireless cellular system. The specific form of the first device is not limited.

Step S902, sending a parameter further obtained based on the inference result to the second device wherein the parameter is forwarded to the third device via the second device; or reporting a parameter further obtained based on the inference result directly to the third device.

In this solution, the third device sends the AI model inference task to the second device in response to receiving information about having AI model inference capability reported by the second device. When the second device does not have the conditions for independent inference the first device responds to receiving the AI model inference request sent by the second device and assists in returning the inference result to the second device or the third device to assist the second device in completing the AI model inference task indirectly enabling the second device to have inference capability and benefiting from wireless AI.

Embodiments of the present disclosure provide another inference method. The method is performed by the first device. The inference method can be executed separately, combined with any of the embodiments or possible implementations in this disclosure, or combined with any technical solution in the related art.

In embodiments of the present disclosure, a new AI inference processing architecture is provided, including a first device, a second device, and a third device. The protocol for interaction between the first device and the second device is a custom interaction protocol defined by the first device and the second device, and the protocol between the first device and the third device is a universal interaction protocol

Embodiments of the present disclosure provide another inference method. FIG. 10 is a schematic flowchart of another inference method provided in an embodiment of the present disclosure. The method is performed by the second device. The inference method can be executed separately, combined with any of the embodiments or possible implementations in this disclosure, or combined with any technical solution in the related art.

As shown in FIG. 10, the inference method may include the following steps.

Step 1001, in response to the second device providing an inference result of an AI model or using an inference result of an AI model, sending an AI model inference request to a first device, wherein the AI model inference request indicates a need to assist the second device in completing an AI model inference task.

In response to receiving information about having AI model inference capability reported by the second device, the third device sends the AI model inference task to the second device. When the second device does not have the conditions for independent inference, the second device sends an AI model inference request to the first device to request assisting the second device in completing the AI model inference task, and the first device assists the second device in completing the AI model inference task.

As a feasible implementation of embodiments of the present disclosure, the first device is a server or processor outside the wireless cellular system. The specific form of the first device is not limited. The second device is a device that does not have conditions for independent inference, such as limited hardware conditions or incompatible AI processing platforms.

In this solution, the third device sends the AI model inference task to the second device. When the second device does not have the conditions for independent inference, the second device sends the AI model inference request to the first device to request assisting the second device in completing the AI model inference task. The first device assists the second device in completing the AI model inference task, so that the second device can respond to the need to provide or use the inference result of the AI model, indirectly enabling the second device to have inference ability and benefiting from wireless AI.

Embodiments of the present disclosure provide another inference method. FIG. 11 is a schematic flowchart of another inference method provided in an embodiment of the present disclosure. The method is performed by the second device. The inference method can be executed separately, combined with any of the embodiments or possible implementations in this disclosure, or combined with any technical solution in the related art.

As shown in FIG. 11, the inference method may include the following steps.

Step 1101, receiving inference capability information for assisting AI model inference sent by the first device.

The first device sends the inference capability information of the AI model to the second device, with the purpose of the second device reporting the obtained inference capability information to the third device, and the third device configuring the second device to perform AI inference tasks based on the received inference capability information of the AI model

The inference capability information of the AI model includes at least one of AI model information, AI processing platform framework information and AI processing capability information, For example, the types of AI models supported are Convolutional Neural Network (CNN), Recurrent Neural Network (RNN), or Transform. The AI processing framework is TensorFlow or Pytorch, and the processing capability information is computing speed, etc.

Step S1102, in response to the second device providing an inference result of the AI model or using an inference result of the AI model, sending an AI model inference request to the first device, wherein the AI model inference request indicates a need to assist the second device in completing an AI model inference mask.

In this solution, the inference capability information of the first device assisting in performing AI model inference is reported to the third device, The third device configures the second device to perform AI inference tasks based on the received inference capability information of the AI model inference. When the second device does not have the conditions for independent inference, the second device sends the AI model inference request to the first device to request assisting the second device in completing the AI model inference task. The first device assists the second device in completing the AI model inference task, so that the second device can respond to the need to provide the inference result of the AI model or use the inference result of the AI model indirectly enabling the second device to have inference capabilities and benefiting from wireless AI.

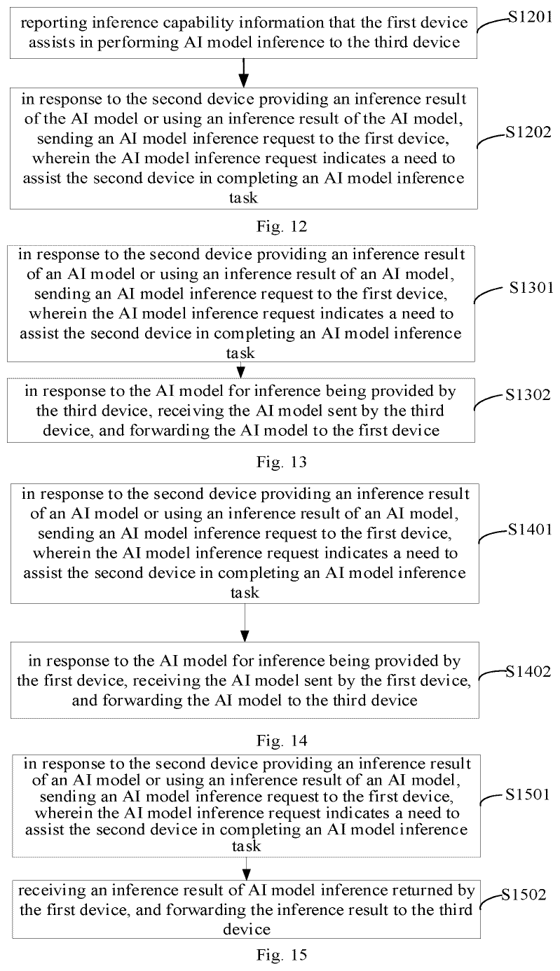

Embodiments of the present disclosure provide another inference method. FIG. 12 is a schematic flowchart of another inference method provided in an embodiment of the present disclosure. The method is performed by the second device. The inference method can be executed separately, combined with any of the embodiments or possible implementations in this disclosure, or combined with any technical solution in the related art.

As shown in FIG. 12, the inference method may include the following steps.

Step S1201, reporting inference capability information that the first device assists in performing AI model inference to the third device.

When the second device does not have the conditions for independent inference, such as limited hardware conditions or incompatible AI processing platforms, the first device can assist the second device in AI inference.

As a feasible implementation of embodiments of the present disclosure, the first device is a server or processor outside the wireless cellular system. The specific form of the first device is not limited.

The first device sends the inference capability information of the AI model to the second device, with the purpose of the second device reporting the obtained inference capability information to the third device. The third device then configures the second device to perform AI inference tasks based on the received inference capability information of the AI model.

The second device acts as a relay to forward the obtained inference capability information to the third device, in order to achieve information synchronization of the AI model during transmission, so that the third device can determine whether to allow the second device to use the functions of the wireless AI model or which wireless AI model use cases to use based on the inference capability information.

The inference capability information of the AI model includes at least one of AI model information, AI processing platform framework information and AI processing capability information. For example, the types of AI models supported are Convolutional Neural Network (CNN), Recurrent Neural Network (RNN), or Transform. The AI processing framework is TensorFlow or Pytorch, and the processing capability information is computing speed, etc.

Step S1202, in response to the second device providing an inference result of the AI model or using an inference result of the AI model, sending an AI model inference request to the first device, wherein the AI model inference request indicates a need to assist the second device in completing an AI model inference task.

In this solution, the inference capability information that the first device assists in AI model inference is reported to the third device. The third device configures the second device to perform AI inference tasks based on the received inference capability information of the AI model inference. When the second device does not have the conditions for independent inference, the second device sends the AI model inference request to the first device to request assisting the second device in completing the AI model inference task. The first device assists the second device in completing the AI model inference task, so that the second device can respond to the need to provide or use the inference result of the AI model, indirectly enabling the second device to have inference ability and benefiting from wireless AI.

Embodiments of the present disclosure provide another inference method. FIG. 13 is a schematic flowchart of another inference method provided in an embodiment of the present disclosure. The method is performed by the second device. The inference method can be executed separately, combined with any of the embodiments or possible implementations in this disclosure, or combined with any technical solution in the related art.

As shown in FIG. 13, the inference method may include the following steps.

Step S1301, in response to the second device providing an inference result of an AI model or using an inference result of an AI model, sending an AI model inference request to the first device, wherein the AI model inference request indicates a need to assist the second device in completing an AI model inference task.

Step 1302, in response to the AI model for inference being provided by the third device for inference, receiving the AI model sent by the third device, and forwarding the AI model to the first device.

For example, when the first device serves as the user of the AI model and the third device serves as the provider of the AI model, the first device receives the AI model transmitted by the third device.

In addition to the direct transmission of the AI model between the first device and the third device, this embodiment of the present disclosure also supports the intermediary of the second device, that is, the third device acts as the provider of the AI model and transmits the AI model to the second device, which then forwards the AI model to the first device. The transmission of the AI model is performed between the first device, the second device, and the third device.

The above process of transmitting the AI model is for illustrative purposes only and is not intended to limit the transmission order of the AI model to only include the implementation of the above examples.

In this solution, in response to the AI model for inference being provided by the third device, the AI model sent by the third device is received and forwarded to the first device. When the second device does not have the conditions for independent inference, the second device sends the AI model inference request to the first device to request assisting the second device in completing the AI model inference task. The first device assists the second device in completing the AI model inference task, so that the second device can respond to the need to provide or use the inference result of the AI model, indirectly enabling the second device to have inference ability and benefiting from wireless AI.

Embodiments of the present disclosure provide another inference method. FIG. 14 is a schematic flowchart of another inference method provided in an embodiment of the present disclosure. The method is performed by the second device. The inference method can be executed separately, combined with any of the embodiments or possible implementations in this disclosure, or combined with any technical solution in the related art.

As shown in FIG. 14, the inference method may include the following steps.

Step S1401, in response to the second device providing an inference result of an AI model or using an inference result of an AI model, sending an AI model inference request to the first device, wherein the AI model inference request indicates a need to assist the second device in completing an AI model inference task.

Step 1402, in response to the AI model for inference being provided by the first device for inference, receiving the AI model sent by the first device, and forwarding the AI model to the third device.

The scenario of the present embodiment is that the first device serves as the provider of the AI model and needs to transmit it to the user of the AI model (the third device). The third device assists the first device in executing the AI model inference task based on the received AI model. When transmitting the AI model from the first device to the third device, the process is similar to the process of the ford device transmitting the AI model to the first device. The first device can directly transmit the AI model from the first device to the third device, or the first device can transmit the AI model to the second device and then the second device can transmit the AI model to the third device. The method of transmitting the AI model is not limited in embodiments of the present disclosure

In this solution, the third device sends the AI model inference task to the second device in response to receiving information about having AI model inference capability reported by the second device. When the second device does not have conditions for independent inference, in response to receiving the AI model inference request sent by the second device, AI model transmission is performed in at least two devices of the first device, the second device, and the third device, to complete the model inference task of the second device, indirectly enabling the second device to have inference capability and benefiting from wireless AI.

Embodiments of the present disclosure provide another inference method. FIG. 15 is a schematic flowchart of another inference method provided in an embodiment of the present disclosure. The method is performed by the second device. The inference method can be executed separately, combined with any of the embodiments or possible implementations in this disclosure, or combined with any technical solution in the related art.

As shown in FIG. 15, the inference method may include the following steps.

Step S1501, in response to the second device providing an inference result of an AI model or using an inference result of an AI model, sending an AI model inference request to the first device, wherein the AI model inference request indicates a need to assist the second device in completing an AI model inference task.

Step S1502, receiving an inference result of AI model inference returned by the first device, and forwarding the inference result to the third device.

As an implementation of embodiments of the present disclosure, after the first device assists the second device in completing the AI model inference task the inference result is returned to the second device and uploaded to the third device by the second device.

As another implementation of embodiments of the present disclosure, after the first device assists the second device in completing the AI model inference task, the inference result is directly returned to the third device.

The network device in the embodiments of the present disclosure is an entity on the network side used for transmitting or receiving signals. For example, the network device can be an evolved NodeB (eNB), a transmission reception point (TRP), a next generation NodeB (gNB) in an NR system, a base station in other future mobile communication systems, or an access node in a wireless fidelity (WiFi) system. The specific technology and device form adopted by the network device is not limited in embodiments of the present disclosure. The network device provided in embodiments of the present disclosure may be composed of a central unit (CU) and a distributed unit (DU), where the CU may also be referred to as a control unit. The CU-DU structure can be used to separate the protocol layers of network device, such as base station, with some protocol layer functions centrally controlled by the CU and the remaining or all protocol layer functions distributed in the DU, which is centrally controlled by the CU.

In this solution, the third device sends the AI model inference task to the second device in response to receiving information about having AI model inference capability reported by the second device. When the second device does not have the conditions for independent inference the first device responds to receiving the AI model inference request sent by the second device and assists in returning the inference result to the second device or the third device to assist the second device in completing the AI model inference task, indirectly enabling the second device to have inference capability and benefiting from wireless AI.

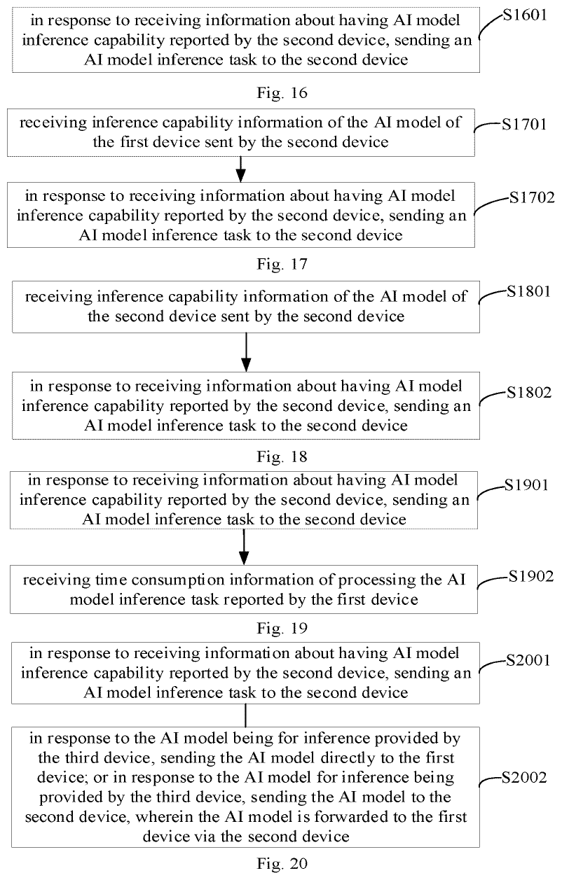

Embodiments of the present disclosure provide another inference method. FIG. 16 is a schematic flowchart of another inference method provided in an embodiment of the present disclosure. The method is performed by the second device. The inference method can be executed separately, combined with any of the embodiments or possible implementations in this disclosure, or combined with any technical solution in the related art.

As shown in FIG. 16, the inference method may include the following steps.

Step S1601, in response to receiving information about having AI model inference capability reported by the second device, sending an AI model inference task to the second device.

The third device sends the AI model inference task to the second device. When the second device does not have the conditions for independent inference, such as limited hardware conditions or incompatible AI processing platforms, the second device sends the AI model inference request to the first device, which assists the second device in completing the AI model inference task.

As a feasible implementation of embodiments of the present disclosure, the first device is a server or processor outside the wireless cellular system. The specific form of the first device is not limited.

In this solution, the third device sends the AI model inference task to the second device. When the second device does not have the conditions for independent inference, in response to the AI model inference request sent by the second device, the second device is assisted in completing the AI model inference task, so that the second device can respond to the need to provide or use the inference result of the AI model, indirectly enabling the second device to have inference ability and benefiting from wireless AI.

Embodiments of the present disclosure provide another inference method. FIG. 17 is a schematic flowchart of another inference method provided in an embodiment of the present disclosure. The method is performed by the third device. The inference method can be executed separately, combined with any of the embodiments or possible implementations in this disclosure, or combined with any technical solution in the related art.

As shown in FIG. 17, the inference method may include the following steps.

Step S1701, receiving inference capability information of the AI model of the first device sent by the second device.

Step S1702, in response to receiving information about having AI model inference capability reported by the second device, sending an AI model inference task to the second device.

When the second device does not have the condition for independent inference, in order for the first device to assist the second device in completing the inference task, the second device reports information about the AI model inference capability in response to the need for the second device to provide the inference result of the AI model or use the inference result of the AI model.

The first device sends the inference capability information of the AI model to the second device, with the purpose of the second device reporting the obtained inference capability information to the third device. The third device then configures the second device to perform AI inference tasks based on the received inference capability information of the AI model. The second device acts as a relay, forwarding the obtained inference capability information to the third device to achieve information synchronization of the AI model during transmission, so that the third device can determine whether to allow the second device to use the functions of the wireless AI model or which wireless AI model use cases to use based on the inference capability information.

The inference capability information of the AI model includes at least one of AI model information, AI processing platform framework information and AI processing capability information. For example, the types of AI models supported are Convolutional Neural Network (CNN), Recurrent Neural Network (RNN), or Transform The AI processing framework is TensorFlow or Pytorch, and the processing capability information is computing speed, etc.

In this solution, the inference capability information that the first device assists in AI model inference is reported to the third device. The third device configures the second device to perform AI inference tasks based on the received inference capability information of the AI model inference. When the second device does not have the conditions for independent inference, the second device sends the AI model inference request to the first device to request assisting the second device in completing the AI model inference task. The first device assists the second device in completing the AI model inference task, so that the second device can respond to the need to provide or use the inference result of the AI model, indirectly enabling the second device to have inference ability and benefiting from wireless AI.

Embodiments of the present disclosure provide another inference method. FIG. 18 is a schematic flowchart of another inference method provided in an embodiment of the present disclosure. The method is performed by the third device. The inference method can be executed separately, combined with any of the embodiments or possible implementations in this disclosure, or combined with any technical solution in the related

As shown in FIG. 18, the inference method may include the following steps.

Step S1801, receiving inference capability information of the AI model of the second device sent by the second device.

The second device reports the inference capability information to the third device, and the third device configures the second device to perform AI inference tasks based on the inference capability information received from the AI model. The inference capability information of the AI model sent by the second device may include, but is not limited to, the inference capability information of the AI model provided by the first device, as well as the second device's own inference capability information of the AI model. The third device does not care about the source of the inference capability information of the AI model, but rather relies on the inference capability information of the AI model provided by the second device to perform AI inference tasks.

The inference capability information of the AI model includes at least one of AI model information, AI processing platform framework information and AI processing capability information. For example, the types of AI models supported are Convolutional Neural Network (CNN), Recurrent Neural Network (RNN), or Transform. The AI processing framework is TensorFlow or Pytorch, and the processing capability is computing speed, etc.

Step S1802, in response to receiving information about having AI model inference capability reported by the second device, sending an AI model inference task to the second device.

In order for the first device to assist the second device in completing the inference task, the second device reports specific information about the AI model inference capability in response to the need for the second device to provide the inference result of the AI model or use the inference result of the AI model

In this solution, the inference capability information of the first device assisting in performing AI model inference is reported to the third device, and the third device configures the second device to perform AI inference tasks based on the received inference capability information of the AI model inference. The second device sends an AI model inference request to the first device to request assisting the second device in completing the AI model inference task, and the first device assists the second device in completing the AI model inference task, so that the second device can respond to the need to provide or use the inference result of the AI model, indirectly enabling the second device to have inference capability and benefiting from wireless AI.

Embodiments of the present disclosure provide another inference method. FIG. 19 is a schematic flowchart of another inference method provided in an embodiment of the present disclosure, The method is performed by the third device. The inference method can be executed separately, combined with any of the embodiments or possible implementations in this disclosure, or combined with any technical solution in the related art.

As shown in FIG. 19, the inference method may include the following steps.

Step S1901, in response to receiving information about having AI model inference capability reported by the second device, sending an AI model inference task to the second device.

Step S1902, receiving time consumption information of processing the AI model inference task reported by the first device.

The first device determines the time consumption/delay information for processing each AI task based on the category of AI task processed in the AI model, and reports the time consumption/delay information to the third device.

In this solution, the third device sends the AI model inference task to the second device in response to receiving information about having AI model inference capability reported by the second device. When the second device does not have the conditions for independent inference, the second device is assisted in completing the AI model inference task in response to receiving the AI model inference request sent by the second device, so that the second device can respond to the need to provide or use the inference result of the AI model, indirectly enabling the second device to have inference capability and benefiting from wireless AI.

Embodiments of the present disclosure provide another inference method. FIG. 20 is a schematic flowchart of another inference method provided in an embodiment of the present disclosure. The method is performed by the third device. The inference method can be executed separately, combined with any of the embodiments or possible implementations in this disclosure, or combined with any technical solution in the related art.

As shown in FIG. 20, the inference method may include the following steps.

Step S2001, in response to receiving information about having AI model inference capability reported by the second device, sending an AI model inference task to the second device.

Step S2002, in response to the AI model for inference being provided by the third device for inference, sending the AI model directly to the first device; or in response to the AI model for inference being provided by the third device for inference, sending the AI model to the second device, wherein the AI model is forwarded to the first device via the second device.

The scenario of embodiments of the present disclosure is that the third device serves as the provider of the AI model and needs to transmit it to the user of the AI model (the first device). The first device assists the first device in executing the AI model inference task based on the received AI model.

The scenario of embodiments of the present disclosure is that the third device serves as the provider of the AI model and needs to transmit it to the second device, which then forwards it to the user of the AI model (the first device), so that the first device, the second device, and the third device can jointly perform the AI model inference task.

In this solution, the third device sends the AI model inference task to the second device in response to receiving information about having AI model inference capability reported by the second device. When the second device does not have the conditions for independent inference, the second device is assisted in completing the AI model inference task in response to receiving the AI model inference request sent by the second device, so that the second device can respond to the need to provide or use the inference result of the AI model, indirectly enabling the second device to have inference capability and benefiting from wireless AI.

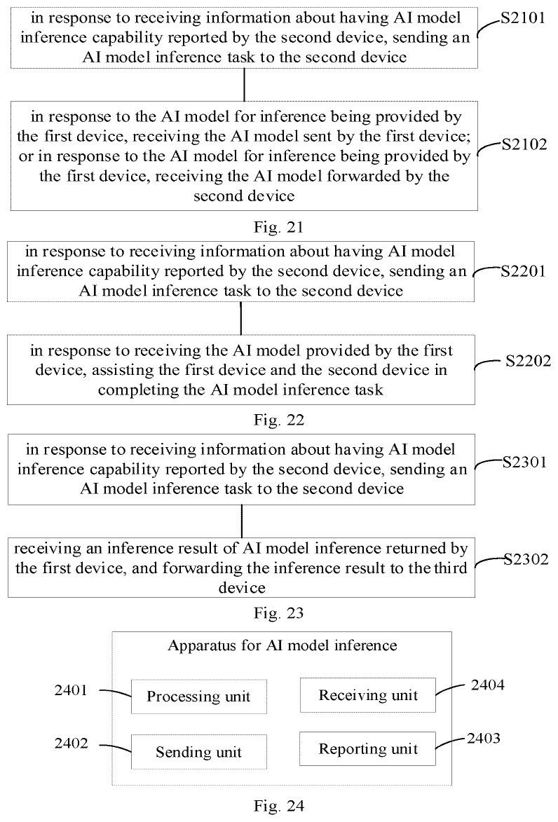

Embodiments of the present disclosure provide another inference method. FIG. 21 is a schematic flowchart of another inference method provided in an embodiment of the present disclosure. The method is performed by the third device. The inference method can be executed separately, combined with any of the embodiments or possible implementations in this disclosure, or combined with any technical solution in the related art.

As shown in FIG. 21, the inference method may include the following steps.

Step S2101, in response to receiving information about having AI model inference capability reported by the second device, sending an AI model inference task to the second device.

Step S2102, in response to the AI model for inference being provided by the first device for inference, receiving the AI model sent by the first device; or in response to the AI model for inference being provided by the first device for inference, receiving the AI model forwarded by the second device.

For the transmission process of the AI model between the first device, the second device, and the third device, please refer to the detailed description of any embodiment, and will not be repeated here.

Embodiments of the present disclosure provide another inference method. FIG. 22 is a schematic flowchart of another inference method provided in an embodiment of the present disclosure The method is performed by the third device. The inference method can be executed separately, combined with any of the embodiments or possible implementations in this disclosure, or combined with any technical solution in the related art.

As shown in FIG. 22, the inference method may include the following steps.

Step S2201, in response to receiving information about having AI model inference capability reported by the second device, sending an AI model inference task to the second device.

Step S2202, in response to receiving the AI model provided by the first device, assisting the first device and the second device in completing the AI model inference task.

Embodiments of the present disclosure provide another inference method. FIG. 23 is a schematic flowchart of another inference method provided in an embodiment of the present disclosure. The method is performed by the third device. The inference method can be executed separately, combined with any of the embodiments or possible implementations in this disclosure, or combined with any technical solution in the related art.

As shown in FIG. 23, the inference method may include the following steps.

Step S2301, in response to receiving information about having AI model inference capability reported by the second device, sending an AI model inference task to the second device.

Step S2302, receiving an inference result of AI model inference returned by the first device, and forwarding the inference result to the third device.

The inference result is: the inference result obtained by the first device independently completing the AI model inference task; or the inference result obtained by the first device and the second device jointly completing the AI model inference task, or the inference result obtained by the first device, the second device and the third device jointly completing the AI model inference task.

In this solution, in response to receiving information about having AI model inference capability reported by the second device, the third device sends the AI model inference task to the second device, and when the second device does not have independent inference conditions, in response to receiving the AI model inference request sent by the second device and returning the inference result to the third device, assists the second device in completing the AI model inference task, indirectly enabling the second device to have inference capability and benefiting from wireless AI.

Corresponding to the inference method provided in the embodiments of FIGS. 2 to 23, this disclosure also provides an inference apparatus. As the inference apparatus provided in this disclosure corresponds to the inference method provided in the embodiments of FIGS. 2 to 23, the implementation of the inference method is also applicable to the inference apparatus provided in this disclosure, and will not be described in detail in this disclosure.

FIG. 24 is a block diagram of an inference apparatus provided in an embodiment of the present disclosure. The apparatus is arranged in a first device, and the apparatus includes:
a processing unit 2401, configured to assist a second device in completing an AI model inference task in response to receiving an AI model inference request sent by the second device, wherein the AI model inference request is sent by the second device to the first device in response to a need to provide or use an inference result of an AI model.

In this solution, the third device sends an AI model inference task to the second device. When the second device does not have the conditions for independent inference, the first device responds to the AI model inference request sent by the second device to assist the second device in completing the AI model inference task, so that the second device can respond to the need to provide or use the inference result of the AI model, indirectly enabling the second device to have inference ability and benefiting from wireless AI.

As a possible implementation of embodiments of the present disclosure, assisting the second device in performing an AI model inference task includes any one of:
the first device independently completing the AI model inference task;
the first device and the second device jointly completing the AI model inference task;
the first device, the second device, and a third device jointly completing the AI model inference task.

As a possible implementation of embodiments of the present disclosure, the apparatus further includes:
a sending unit 2402, configured to send inference capability information of the AI model of the first device to the second device.

As a possible implementation of embodiments of the present disclosure, the inference capability information of the AI model includes:
AI model information, AI processing platform framework information, and AI processing capability information.

As a possible implementation of embodiments of the present disclosure, the apparatus further includes:
a reporting unit 2403, configured to report time consumption information of processing the AI model inference task to the third device.

As a possible implementation of embodiments of the present disclosure, the apparatus further includes:
a receiving unit 2404, configured to receive the AI model sent by the third device, in response to the AI model for inference being provided by the third device; or,
the receiving unit 2404 is further configured to receive the AI model forwarded by the second device, in response to the AI model for inference being provided by the third device.

As a possible implementation of embodiments of the present disclosure, the apparatus further includes:
a sending unit 2402, configured to send the AI model to the second device, in response to the AI model for inference being provided by the first device, wherein the AI model is forwarded to the third device via the second device; or
the sending unit 2402 is further configured to send the AI model directly to the third device, in response to the AI model for inference being provided by the first device.

As a possible implementation of embodiments of the present disclosure, the apparatus further includes:
a sending unit 2402, configured to send the inference result to the second device, wherein the inference result is forwarded to the third device via the second device; or
report the inference result directly to the third device.

As a possible implementation of embodiments of the present disclosure, the apparatus further includes:
a sending unit 2402, configured to send a parameter further obtained based on the inference result to the second device, wherein the parameter is forwarded to the third device via the second device; or
a reporting unit 2403, configured to report a parameter further obtained based on the inference result directly to the third device.

As a possible implementation of embodiments of the present disclosure, a protocol for interaction between the first device and the second device is a custom interaction protocol.

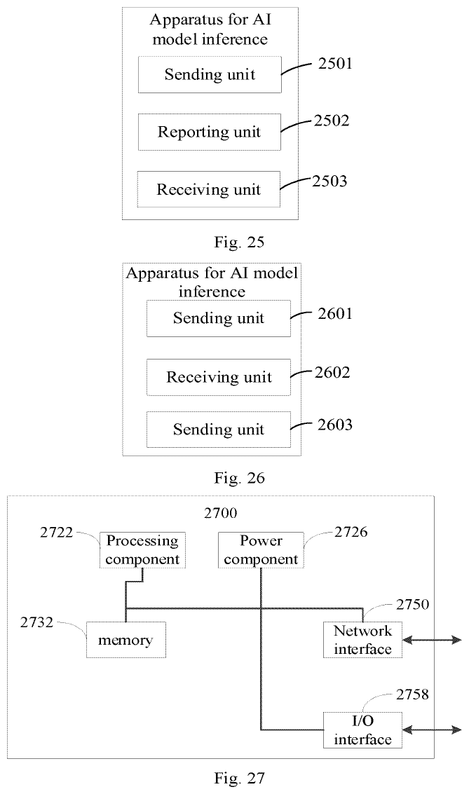

As a possible implementation of embodiments of the present disclosure, embodiments of the present disclosure provide an apparatus for AI model inference. The apparatus is arranged in a second device, and as shown in FIG. 25, the apparatus includes:
a sending unit 2501, configured to send an AI model inference request to the first device in response to the second device providing or using an inference result of an AI model, wherein the AI model inference request indicates a need to assist the second device in completing an AI model inference task.

In this solution, the third device sends an AI model inference task to the second device. When the second device does not have the conditions for independent inference, in response to the AI model inference request sent by the second device, the second device is assisted in completing the AI model inference task, so that the second device can respond to the need to provide or use the inference results of the AI model, indirectly enabling the second device to have inference ability and benefiting from wireless AI.

As a possible implementation of embodiments of the present disclosure, the apparatus further includes:
a receiving unit 2502, configured to receive inference capability information for assisting in performing AI model inference sent by the first device.

As a possible implementation of embodiments of the present disclosure, the apparatus further includes:
a reporting unit 2503, configured to report the inference capability information of the first device assisting in performing AI model inference to the third device.

As a possible implementation of embodiments of the present disclosure, the inference capability information includes:
AI model information, AI processing platform framework information, and AI processing capability information.

As a possible implementation of embodiments of the present disclosure, the apparatus further includes:
a receiving unit 2502, configured to receive the AI model sent by a third device, and forward the AI model to the first device, in response to the AI model for inference being provided by the third device.

As a possible implementation of embodiments of the present disclosure, the apparatus further includes:
a receiving unit 2502, configured to, in response to the AI model for inference being provided by the first device, receive the AI model sent by the first device, and forward the AI model to the third device.

In an implementation, the apparatus further includes:
a receiving unit 2502, configured to receive the inference result of the AI model returned by the first device, and forwarding the inference result to a third device.

As a possible implementation of embodiments of the present disclosure, the inference result is:
the inference result obtained by the first device independently completing the AI model inference task; or
the inference result obtained by the first device and the second device jointly completing the AI model inference task; or
the inference result obtained by the first device, the second device, and the third device jointly completing the AI model inference task.

As a possible implementation of embodiments of the present disclosure, a protocol for interaction between the second device and the first device is a custom interaction protocol.

As a possible implementation of embodiments of the present disclosure, embodiments of the present disclosure provide an apparatus for AI model inference. The apparatus is arranged in a third device, and as shown in FIG. 26, the apparatus includes:
a sending unit 2601, configured to send an AI model inference task to a second device in response to receiving information reported by the second device about having AI model inference capability, so that the first device assists the second device in completing the inference task, and the second device reports specific information of AI model inference capability in response to a need for the second device to provide or use an inference result of the AI model.

In this solution, the third device sends an AI model inference task to the second device. When the second device does not have the conditions for independent inference, the first device responds to the AI model inference request sent by the second device and assists the second device in completing the AI model inference task, so that the second device can respond to the need to provide or use the inference result of the AI model, indirectly enabling the second device to have inference ability and benefiting from wireless AI.

As a possible implementation of embodiments of the present disclosure, the apparatus further includes:
a receiving unit 2602, configured to receive inference capability information of the AI model of the first device sent by the second device.

As a possible implementation of embodiments of the present disclosure, the apparatus further includes:
a receiving unit 2602, configured to receive inference capability information of the AI model of the second device sent by the second device.

As a possible implementation of embodiments of the present disclosure, the inference capability information of the AI model includes AI model information, AI processing platform framework information, and AI processing capability information.

As a possible implementation of embodiments of the present disclosure, the apparatus further includes:
a receiving unit 2602, configured to receive time consumption information of processing the AI model inference task reported by the first device.

As a possible implementation of embodiments of the present disclosure, the apparatus further includes:
a sending unit 2603, configured to, in response to the AI model for inference being provided by the third device, send the AI model to the first device; or,
a sending unit 2603, configured to, in response to the AI model for inference being provided by the third device, send the AI model to the second device, wherein the AI model is forwarded to the first device via the second device.

As a possible implementation of embodiments of the present disclosure, the apparatus further includes:
a receiving unit 2602, configured to, in response to the AI model for inference being provided by the first device, receive the AI model sent by the first device; or
a receiving unit 2602, configured to, in response to the AI model for inference being provided by the first device, receive the AI model forwarded by the second device.

As a possible implementation of embodiments of the present disclosure, the processing unit 2601 is configured to, in response to receiving the AI model provided by the first device, assist the first device and the second device in completing the AI model inference task.

As a possible implementation of embodiments of the present disclosure, the apparatus further includes:
a receiving unit 2602, configured to receive an inference result of the AI model sent by the second device.

As a possible implementation of embodiments of the present disclosure, the inference result is:
the inference result obtained by the first device independently completing the AI model inference task; or
the inference result obtained by the first device and the second device jointly completing the AI model inference task; or
the inference result obtained by the first device, the second device, and the third device jointly completing the AI model inference task.

In order to implement the above embodiments, the present disclosure also provides another inference device, including: a processor and an interface circuit;
the interface circuit is configured to receive code instructions and transmit them to the processor;
the processor is configured to execute the code instructions to perform the methods shown in FIGS. 2 to 9, or to perform the methods shown in FIGS. 10 to 15, or to perform the methods shown in FIGS. 16 to 23.

In order to implement the various functions provided in the method of the present disclosure, the first device, the second device, and the third device may include hardware structures and software modules, and the above-mentioned functions may be implemented in the form of hardware structures, software modules, or a combination of hardware structures and software modules. One of the above functions can be executed in the form of hardware structure, software module, or a combination of hardware structure and software module.

Please refer to FIG. 27, which is a block diagram of an inference device provided in an embodiment of the present disclosure. Referring to FIG. 27, the network device 2700 includes a processing component 2722, which further comprises at least one processor, and memory resources represented by the memory 2732 for storing instructions, such as application programs, that can be executed by the processing component 2722. The application program stored in the memory 2732 may include one or more modules each corresponding to a set of instructions. In addition, the processing component 2722 is configured to execute instructions to perform any of the methods previously applied to the network device, such as the methods described in the embodiments of FIGS. 2-21.

The network device 2700 may also include a power component 2706 configured to perform power management for the network device 2700, a wired or wireless network interface 2750 configured to connect the network device 2700 to the network, and an input/output (I/O) interface 2758. The network device 2700 can operate operating systems stored in the memory 2732, such as Windows Server™, Mac OS X™, Unix™, Linux™, FreeBSD™, or similar.

In order to implement the above embodiments, the present disclosure provides an inference system, including: the inference device as shown in FIG. 24, the inference device as shown in FIG. 25, and the inference device as shown in FIG. 26.

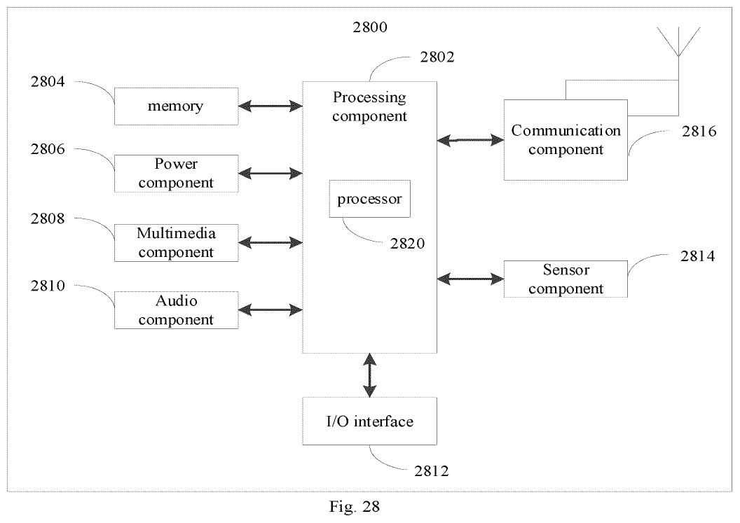

FIG. 28 is a block diagram of an inference device provided in an embodiment of the present disclosure. For example, the user device 2800 may be a mobile phone, computer, digital broadcasting terminal, messaging device, game console, tablet device, medical device, fitness device, personal digital assistant, etc.

Referring to FIG. 28, the user device 2800 may include one or more of the following components: a processing component 2802, a memory 2804, a power component 2806, a multimedia component 2808, an audio component 2810, an input/output (I/O) interface 2812, a sensor component 2814, and a communication component 2816.

The processing component 2802 typically controls overall operations of the user device 2800, such as the operations associated with display, telephone calls, data communications, camera operations, and recording operations. The processing component 2802 may include one or more processors 2820 to execute instructions. Moreover, the processing component 2802 may include one or more modules which facilitate the interaction between the processing component 2802 and other components. For instance, the processing component 2802 may include a multimedia module to facilitate the interaction between the multimedia component 2808 and the processing component 2802.

The memory 2804 is configured to store various types of data to support the operation of the user device 2800. Examples of such data include instructions for any applications or methods operated on the user device 2800, contact data, phonebook data, messages, pictures, video, etc. The memory 2804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 2806 provides power to various components of the user device 2800. The power component 2806 may include a power management system, one or more power sources, and any other components associated with the generation, management, and distribution of power in the user device 2800.

The multimedia component 2808 includes a screen providing an output interface between the user device 2800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 2808 includes a front camera and/or a rear camera When the user device 2800 is in an operation mode, such as a shooting mode or a video mode, the front camera and/or the rear camera can receive external multimedia data. Each front camera and rear camera can be a fixed optical lens system or have focal length and optical zoom capabilities.

The audio component 2810 is configured to output and/or input audio signals. For example, the audio component 2810 includes a microphone (“MIC”) configured to receive an external audio signal when the user device 2800 is in an operation mode, such as a call mode, a recording mode, and a voice recognition mode. The received audio signal may be further stored in the memory 2804 or transmitted via the communication component 2816. In some embodiments, the audio component 2810 further includes a speaker for outputting audio signals.

The I/O interface 2812 provides an interface between the processing component 2802 and peripheral interface modules, such as a keyboard, a click wheel, buttons, and the like. The buttons may include but are not limited to: home button, volume button, start button, and lock button.

The sensor component 2814 includes one or more sensors to provide status assessments of various aspects of the user device 2800. For instance, the sensor component 2814 may detect an open/closed status of the user device 2800, relative positioning of components, e.g., the display and the keypad, of the user device 2800, a change in position of the user device 2800 or a component of the user device 2800, a presence or absence of a target object contact with the user device 2800, an orientation or an acceleration/deceleration of the user device 2800, and a change in temperature of the user device 2800. The sensor component 2814 may include a proximity sensor configured to detect the presence of nearby objects without any physical contact. The sensor component 2814 may also include a light sensor, such as a CMOS or CCD image sensor, applicable for imaging applications. In some embodiments, the sensor component 2814 may also include an acceleration sensor, a gyroscope sensor, a magnetic sensor, a pressure sensor or a temperature sensor.

The communication component 2815 is configured to facilitate communication, wired or wirelessly, between the user device 2800 and other devices. The user device 2800 can access a wireless network based on a communication standard, such as WiFi, 2G, or 3G, or a combination thereof. In one exemplary embodiment, the communication component 2218 receives a broadcast signal or broadcast associated information from an external broadcast management system via a broadcast channel In one exemplary embodiment, the communication component 2218 further includes a near field communication (NFC) module to facilitate short-range communications. For example, the NFC module may be implemented based on a radio frequency identity (RFID) technology, an infrared data association (IrDA) technology, an ultra-wideband (UWB) technology, a Bluetooth (BT) technology, and other technologies.

In exemplary embodiments, the user device 2800 may be implemented with one or more application specific integrated circuits (ASICs), digital signal processors (DSPs), digital signal processing devices (DSPDs), programmable logic devices (PLDs), field programmable gate arrays (FPGAS), controllers, micro-controllers, microprocessors, or other electronic components, to execute the method shown in FIGS. 1-11.

In exemplary embodiments, there is also provided a non-transitory computer readable storage medium such as a memory 2804 storing instructions, which may be executed by a processor 2820 of the user device 2800 to implement the method shown in FIGS. 2-21. For example, the non-transitory readable storage medium may be a ROM, a RAM, a CD-ROM, a magnetic tape, a floppy disc, an optical data storage device, and the like.

Technicians in this field can also understand that various illustrative logical blocks and steps listed in the embodiments of the present disclosure can be implemented through electronic hardware, computer software, or a combination of both. Whether such functionality is implemented through hardware or software depends on the specific application and the design requirements of the entire system. Technicians in this field can use various methods to implement the described functions for each specific application, but such implementation should not be understood as exceeding the scope of protection of the disclosed embodiments.

In the above embodiments, it can be fully or partially implemented through software, hardware, firmware, or any combination thereof. When implemented using software, it can be fully or partially implemented in the form of a computer program product. The computer program product includes one or more computer programs. When loading and executing the computer program on a computer, all or part of the process or function described in embodiments of the present disclosure is generated. The computer may be a general-purpose computer, a specialized computer, a computer network, or other programmable device. The computer program can be stored in a computer-readable storage medium or transmitted from one computer-readable storage medium to another For example, the computer program can be transmitted from a website site, computer, server, or data center to another website site, computer, server, or data center via wired (such as coaxial cable, fiber optic, digital subscriber line (DSL)) or wireless (such as infrared, wireless, microwave, etc.) means. The computer-readable storage medium can be any available medium that a computer can access, or a data storage device such as a server or data center that integrates one or more available media. The available media can be magnetic media (such as floppy disks, hard disks, magnetic tapes), optical media (such as high-density digital video discs (DVD), or semiconductor media (such as solid state disks (SSDs)).

Those skilled in the art can understand that the first, second, and other numerical numbers mentioned in this disclosure are only for the convenience of description and are not intended to limit the scope of the disclosed embodiments, but also indicate the order of occurrence.

“At least one” in the present disclosure can also be described as one or more, and “multiple” \can be two, three, four, or more, without limitation in this disclosure. In embodiments of the present disclosure, for a type of technical feature, the technical features in the type of technical feature are distinguished by “first”, “second”, “third”, “A”, “B”, “C”, and “D”, etc. The technical features described by “first”, “second”, “third”, “A”, “B”, “C”, and “D” have no order of priority or size.

The correspondence relationships shown in each table in this disclosure can be configured or predefined. The values of the information in each table are only examples and can be configured as other values, which are not limited by this disclosure. When configuring the correspondence between information and various parameters, it is not necessarily required to configure all the correspondence relationships shown in each table. For example, in the table disclosed herein the correspondence relationships shown in certain rows may not be configured. For another example, appropriate deformation adjustments can be made based on the above table, such as splitting, merging, and so on. The titles in the above tables indicate that the names of the parameters can also be other names that the communication device can understand, and the values or representations of the parameters can also be other values or representations that the communication device can understand. The above tables can also be implemented using other data structures, such as arrays, queues, containers, stacks, linear tables, pointers, linked lists, trees, graphs, structures, classes, heaps, hash tables, etc.

The predefined in this disclosure can be understood as defined, defined in adventure, stored, pre-stored, pre-negotiated, pre-configured, solidified, or pre-fired.

Those skilled in the art will recognize that the units and algorithm steps described in the embodiments of the present disclosure can be implemented using electronic hardware, or a combination of computer software and electronic hardware. Whether these functions are executed in hardware or software depends on the specific application and design constraints of the technical solution. Professional technicians can use different methods to achieve the described functionality for each specific application, but such implementation should not be considered beyond the scope of this disclosure.

Technicians in the relevant field can clearly understand that, for the convenience and conciseness of description, the specific working process of the system, device, and unit described above can refer to the corresponding process in the aforementioned method embodiments, which will not be repeated here.

The above is only a specific implementation of the present disclosure, but the scope of protection of the present disclosure is not limited to this. Any skilled person familiar with the technical field can easily think of changes or replacements within the technical scope disclosed in the present disclosure, which should be included in the scope of protection of the present disclosure. Therefore, the scope of protection of this disclosure should be based on the scope of protection of the claims.

1. A method for artificial intelligence (AI) model inference, performed by a first device, comprising:
in response to receiving an AI model inference request sent by a second device, assisting the second device in completing an AI model inference task, wherein the AI model inference request is sent by the second device to the first device in response to a need to provide or use an inference result of an AI model.

2. The method of claim 1, wherein assisting the second device in performing the AI model inference task comprises any one of:
the first device completing the AI model inference task;
the first device and the second device completing the AI model inference task; or
the first device, the second device, and a third device jointly completing the AI model inference task.

3. The method of claim 1, further comprising:
sending inference capability information of the AI model of the first device to the second device.

4. The method of claim 3, wherein the inference capability information of the AI model comprises:
AI model information, AI processing platform framework information, and AI processing capability information.

5. The method of claim 2, further comprising:
reporting time consumption information of completing the AI model inference task to the third device.

6. The method of claim 1, further comprising:
in response to the AI model for inference being provided by the third device, receiving the AI model sent by the third device;
in response to the AI model for inference being provided by the third device, receiving the AI model forwarded by the second device;
in response to the AI model for inference being provided by the first device, sending the AI model to the second device, wherein the AI model is forwarded to the third device via the second device; or
in response to the AI model for inference being provided by the first device, sending the AI model directly to the third device.

7. (canceled)

8. The method of claim I, further comprising:
sending the inference result to the second device, wherein the inference result is forwarded to the third device via the second device; or
reporting the inference result to the third device; and/or
sending a parameter obtained based on the inference result to the second device, wherein the parameter is forwarded to the third device via the second device; or
reporting a parameter obtained based on the inference result to the third device.

9. (canceled)

10. (canceled)

11. A method for artificial intelligence (AI) model inference, performed by a second device, comprising:
in response to the second device providing or using an inference result of an AI model, sending an AI model inference request to the first device, wherein the AI model inference request indicates a need to assist the second device in completing an AI model inference task.

12. The method of claim 11, further comprising:
receiving inference capability information for assisting in performing AI model inference sent by the first device.

13. The method of claim 12, further comprising:
reporting the inference capability information of the first device assisting in performing AI model inference to the third device; and
wherein the inference capability information comprises:
AI model information, AI processing platform framework information, and AI processing capability information

14. (canceled)

15. The method of claim 11, further comprising one of:
in response to the AI model for inference being provided by a third device, receiving the AI model sent by the third device, and forwarding the AI model to the first device; or
in response to the AI model for inference being provided by the first device, receiving the AI model sent by the first device, and forwarding the AI model to the third device.

16. (canceled)

17. The method of claim 11, further comprising:
receiving the inference result of the AI model returned by the first device, and forwarding the inference result to a third device.

18-19. (canceled)

20. A method for artificial intelligence (AI) model inference, performed by a third device, comprising:
in response to receiving information reported by a second device about having AI model inference capability, sending an AI model inference task to the second device.

21. The method of claim 20, further comprising at least one of:
receiving inference capability information of the AI model of the first device sent by the second device; or
receiving inference capability information of the AI model of the second device sent by the second device.

22. (canceled)

23. The method of claim 21, wherein the inference capability information of the AI model comprises AI model information, AI processing platform framework information, and AI processing capability information.

24. The method of claim 20, further comprising at least one of:
receiving time consumption information of processing the AI model inference task reported by the first device; or
receiving an inference result of the AI model sent by the second device.

25. The method of claim 20, further comprising:
in response to the AI model for inference being provided by the third device, sending the AI model to the first device;
in response to the AI model for inference being provided by the third device, sending the AI model to the second device, wherein the AI model is forwarded to the first device via the second device;
in response to the AI model for inference being provided by the first device receiving the AI model sent by the first device:
in response to the AI model for inference being provided by the first device, receiving the AI model forwarded by the second device; or
in response to receiving the AI model provided by the first device, assisting the first device and the second device in completing the AI model inference task.

26-32. (canceled)

33. An inference device, comprising a processor and a memory, wherein the memory stores a computer program, and the processor is configured to execute the computer program stored in the memory to cause the device to implement the method of claim 1.

34. An inference device, comprising a processor and a memory, wherein the memory stores a computer program, and the processor is configured to execute the computer program stored in the memory to cause the device to implement the method of claim 11.

35. An inference device, comprising a processor and a memory, wherein the memory stores a computer program, and the processor is configured to execute the computer program stored in the memory to cause the device to implement the method of claim 20.

36-42. (canceled)
